(19) United States
(12) Patent Application Publication
(10) Pub. No.: US 2017/0364764 A1
(43) Pub. Date: Dec. 21, 2017

(54) IMAGE TRANSFER METHOD AND IMAGE RECOGNITION METHOD USEFUL IN IMAGE RECOGNITION PROCESSING BY SERVER

(71) Applicant: CANON IMAGING SYSTEMS INC., Niigata-shi (JP)

(72) Inventor: Yasushi INABA, Niigata-shi (JP)

(21) Appl. No.: 15/617,068

(22) Filed: Jun. 8, 2017

(30) Foreign Application Priority Data
Jun. 15, 2016 (JP) 2016-118737

(51) Int. Cl. G06K 9/00; G06F 9/455; G06K 9/03

(52) U.S. Cl. CPC G06K 9/00979; G06K 9/03; G06F 9/455; G06K 9/00288; G06K 9/00724

(57) ABSTRACT

An image transfer method and an image recognition method that are useful in performing an image recognition process on photographs (photographed images) of participants taken at events. In the image transfer method, moving image data is generated by converting image data received from an outside to moving image frames, and is transmitted to an image recognition device. In the image recognition method, at least one virtual computer is activated. The moving image data from an image transfer device is stored in a cloud data storage section. The virtual computer receives the stored moving image data, and performs the image recognition process on image data converted from the moving image data. The virtual computer transmits processing results to the cloud data storage section. The virtual computer is terminated after termination of the image recognition process.

### BACKGROUND OF THE INVENTION

### Field of the Invention

The present invention relates to an image transfer method and an image recognition method that are useful in processing photographed images which are photographed at events, such as a marathon race.

### Description of the Related Art

There has been proposed a service for selling photographs tagged with respective numbers of number cards of persons appearing in the photographs which are taken at events, such as a marathon race, at a website on the Internet (see Pic2Go Ltd, ┌HOW IT WORKS┘, [Photograph athletes & Upload photos to Pic2Go system], searched in Jun. 8, 2016, Internet <URL: http://www1.pic2go.com/how-it-works>). In the above-mentioned service, bibs (number cards) are used to which two dimensional bar codes are added. A cameraman who took the photographs transfers image files to a server on the Internet, where the two dimensional bar codes are read.

However, in the service provided by Pic2Go Ltd, ┌HOW IT WORKS┘, [Photograph athletes & Upload photos to Pic2Go system], searched in Jun. 8, 2016, Internet <URL:http://www1.pic2go.com/how-it-work>, to instantaneously obtain results of person recognition from photographs, it is required to increase the number of servers to two or more, since events, such as a marathon race, tend to be held concentratedly on weekends. Further, if the number of servers is increased to two or more, the servers are more likely to be in a nonoperating state on weekdays, which can degrade the utilization rate of the servers although the investment cost of an infrastructure environment is increased.

Further, when a cameraman transmits photographs, taken by him/her, to the servers, the number of files and the size of each file are very large, so that it takes very long time to transfer the files. Furthermore, in a case where a plurality of cameramen simultaneously transmit photographed images to the servers, there is a possibility that an error occurs or an image recognition process is delayed due to delay of transfer or failure of transmission of files occurring in the Internet, load on the server for capturing images, and so forth. Particularly in a case where a large number of image files are transmitted, it is difficult to check whether or not the image recognition process has been completed for all the files.

### SUMMARY OF THE INVENTION

The present invention provides an image transfer method and an image recognition method that are useful in performing an image recognition process on photographs (photographed images) of participants taken at events, such as a marathon race, by using a server.

In a first aspect of the present invention, there is provided an image transfer method of an image transfer device interconnected to an image recognition device via a network, comprising storing image data received from an outside in an image storage section, generating moving image data in which moving image frames are formed from the image data stored in the image storage section by said storing, and transmitting the moving image data generated by said generating to the image recognition device.

In a second aspect of the present invention, there is provided an image recognition method of an image recognition device interconnected to an image transfer device via a network, comprising activating at least one virtual computer by a virtual computer controller, storing moving image data received from the image transfer device in a moving image storage section, receiving the moving image data stored in the moving image storage section, by said at least one virtual computer, performing an image recognition process on image data rasterized from the received moving image data, by said at least one virtual computer, transmitting a processing result of the image recognition process to the moving image storage section, by said at least one virtual computer, and terminating said at least one virtual computer, by said virtual computer controller, based on an instruction from the image transfer device after termination of the image recognition process.

According to the present invention, by performing the image recognition process after converting photographed images to a moving image file and transferring the moving image file to a server, it is possible to reduce the size and transfer time period of image files to be transferred.

Further features of the present invention will become apparent from the following description of exemplary embodiments (with reference to the attached drawings).

### BRIEF DESCRIPTION OF THE DRAWINGS

FIG. 1 is a block diagram of an image processing system according to an embodiment of the present invention.

FIG. 2 is a flowchart of an image transfer process by an image transfer section.

FIG. 3 is a flowchart of a cloud control process by a cloud controller.

FIG. 4 is a flowchart of a result transfer process by a result transfer section.

FIGS. 5A to 5C are diagrams useful in explaining an example of a moving image file generated as a transfer file by an image conversion section.

FIG. 6 is a flowchart of an image recognition process by a cloud virtual computer section.

### DESCRIPTION OF THE EMBODIMENTS

The present invention will now be described in detail below with reference to the accompanying drawings showing embodiments thereof.

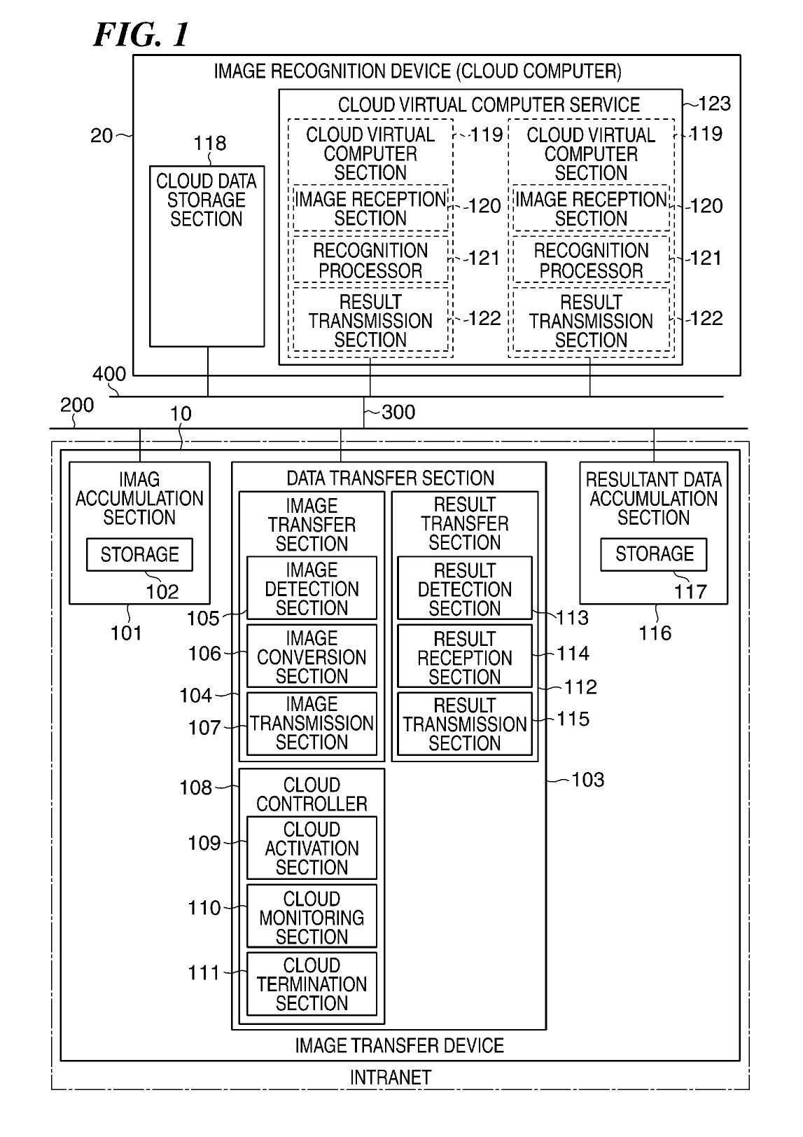

FIG. 1 is a block diagram of an image processing system according to an embodiment of the present invention.

An intranet is connected to a cloud computer via an Internet connection 300. An image transfer device 10 within the intranet includes an image accumulation section 101, a data transfer section 103, and a resultant data accumulation section 116. Further, an image recognition device 20 of the cloud computer includes a cloud data storage section 118 and a cloud virtual computer service 123. The cloud virtual computer service 123 includes cloud virtual computer sections 119 (in FIG. 1, two of them are shown as activated). The configurations of the respective sections mentioned above will be described in detail hereinafter. Note that a camera, not shown, is wiredly or wirelessly connected to the image transfer device 10, and image data of an image photographed by a cameraman is transmitted from the camera to the image accumulation section 101 of the image transfer device 10, and is stored in the image accumulation section 101. Examples of wired connection and wireless connection include Wi-Fi (registered trademark) connection, Bluetooth (registered trademark) connection, USB connection, and so forth. The camera transmits image data to the image transfer device 10 at timing, such as after an entire photographing operation has been completed, whenever a predetermined amount of image data is obtained by photographing, or in real time in parallel with photographing.

First, a description will be given of the construction of the image transfer device 10 in the intranet. The image accumulation section 101 for storing image files photographed at events, such as a marathon race, the data transfer section 103, and the resultant data accumulation section 116 for storing resultant data files obtained by image recognition are connected to a network 200 in the intranet.

A storage 102 for accumulating the image files and a storage 117 for accumulating the resultant data files are arranged in the image accumulation section 101 and the resultant data accumulation section 116, respectively. In the present embodiment, the image accumulation section 101 and the resultant data accumulation section 116 may be the same NAS (Network Attached Storage), and further may be storages, such as hard disks within a computer.

The data transfer section 103 includes an image transfer section 104, a cloud controller 108, and a result transfer section 112. The network 200 within the intranet is connected to a network 400 in the cloud computer via the Internet connection 300. The Internet connection 300 may be wiredly connected to the networks 200 and 400 or may be wirelessly connected thereto by 3G or LTE (Long Term Evolution).

The image transfer section 104 includes an image detection section 105, an image conversion section 106, and an image transmission section 107.

After starting processing, the image detection section 105 periodically monitors files in the storage 102 of the image accumulation section 101, which is set in advance according to photographing attributes set for monitoring e.g. on an event-by-event basis, on a cameraman-by-cameraman basis, or on a camera type-by-camera type basis, and detects image files which are received from the camera and newly stored in the storage 102. Then, the image detection section 105 reads the newly stored image files into the image transfer section 104. The new image files are detected by acquiring file names and generation times thereof from the storage 102 (folder) at the time of monitoring, and determining differences between results of the respective acquisitions.

The image conversion section 106 converts a plurality of image files which are acquired from the read image files and are equal to each other in vertical pixel number and horizontal pixel number, to one moving image file such that the image files become images of respective frames of the moving image file (generation of the moving image file). Note that the maximum number of frames may be set such that it does not take much time to complete the processing, by focusing on only vertical and horizontal pixel sizes without referring to an image attribute related to a direction of rotation of the image.

Further, the image conversion section 106 generates an image information file by writing therein image attributes, such as original vertical and horizontal pixel numbers, rotation direction information, and a photographing time, of each image, such that the image attributes can be referred to in a case where each frame of the moving image file is converted to an image file. Then, when the generation of the moving image file and the image information file has been completed, the image conversion section 106 moves the moving image file and the image information file to a transmission folder, not shown, in the image transmission section 107. In a case where it is impossible to convert the image files to a moving image file, the image files are directly moved to the transmission folder.

The image transmission section 107 monitors the transmission folder, and when detecting a moving image file and an image information file generated by the image conversion section 106, or image files, the image transmission section 107 sequentially (continuously) transmits them to a folder, not shown, of the cloud data storage section 118, which is associated with the photographing attributes set in the image detection section 105 for monitoring e.g. on an event-by-event basis, on a cameraman-by-cameraman basis, or on a camera type-by-camera type basis.

The cloud controller 108 includes a cloud activation section 109, a cloud monitoring section 110, and a cloud termination section 111.

When the moving image file and the image information file generated by the image conversion section 106 or the image files are transmitted from the image transmission section 107 to the cloud data storage section 118, the cloud activation section 109 transmits an activation command for activating the cloud virtual computer section 119 (described hereinafter) to the cloud virtual computer service 123 (described hereinafter).

The cloud monitoring section 110 monitors a state of the cloud virtual computer section 119, described hereinafter.

When an image recognition process by the activated cloud virtual computer section 119 is normally terminated, the cloud termination section 111 transmits a termination command for terminating the cloud virtual computer section 119 to the cloud virtual computer service 123, described hereinafter. The term “normal termination of the image recognition process”, mentioned here, refers to a case where the number of a plurality of image files converted to one moving image file by the image conversion section 106, and transmitted as the moving image file by the image transmission section 107 to the cloud virtual computer section 119 is equal to the number of image files subjected to the image recognition process by the cloud virtual computer section 119. Note that even when the number of the image files transmitted to the cloud virtual computer section 119 and the number of the image files subjected to the image recognition process are not completely equal to each other, if a ratio of the number of the image files subjected to the image recognition process to the number of the transmitted image files reaches a threshold value (85%, 90%, etc.) within a predetermined time period, it may be regarded that the image recognition process has been normally terminated.

The result transfer section 112 includes a result detection section 113, a result reception section 114, and a result transmission section 115.

The result detection section 113 periodically monitors recognition result files of the image recognition process, which are stored in the cloud data storage section 118 of the image recognition device 20 in the network 400 in the cloud computer, to check whether or not a recognition result file is generated. If a recognition result file is generated, the result detection section 113 notifies the result reception section 114 of the fact.

The result reception section 114 receives the recognition result file generated in the cloud data storage section 118, and stores the recognition result file in a folder, not shown, of the result reception section 114.

The result transmission section 115 transmits the recognition result file stored in the folder of the result reception section 114 to a folder, not shown, of the storage 117 of the resultant data accumulation section 116, which is set in advance according to the photographing attributes set for monitoring e.g. on an event-by-event basis, on a cameraman-by-cameraman basis, or on a camera type-by-camera type basis.

Next, a description will be given of the construction of the image recognition device 20 of the cloud computer. The cloud data storage section 118 storing image data files (hereafter, a moving image file and image files are generically referred to as image data files, when deemed appropriate) and an image information file, the cloud virtual computer sections 119, and the cloud virtual computer service 123 are connected to the network 400 of the cloud computer.

The cloud virtual computer service 123 provides services of the cloud computer for activating, terminating, and state monitoring of each cloud virtual computer section 119, and is capable of receiving commands from the cloud controller 108.

When a moving image file and an image information file associated therewith or image files are stored in the cloud data storage section 118, the cloud virtual computer section 119 is activated by the cloud virtual computer service 123 according to an activation command transmitted from the cloud activation section 109 to the cloud virtual computer service 123. In a case where there is no image data file to be subjected to the image recognition process, the cloud virtual computer section 119 is not activated. However, it is possible to scale out the cloud virtual computer section 119 in response to an instruction from the cloud activation section 109 such that a plurality of cloud virtual computer sections 119 are activated according to photographing attributes set e.g. on an event-by-event basis, on a cameraman-by-cameraman basis, or on a camera type-by-camera type basis, which are transmitted from the image transmission section 107. Further, in a case where the number of image files photographed at a specific event or by a specific cameraman is very large, the cloud activation section 109 may compare the number or the total file size of the image files with a threshold value of the number or a threshold value of the total file size, set in advance, and on condition that the number is not smaller than the threshold valve, the cloud activation section 109 may activate a plurality of cloud virtual computer sections 119 by scaling out the cloud virtual computer section 119. Furthermore, even in the course of the image recognition process by a recognition processor 121, referred to hereinafter, it is possible to scale out the cloud virtual computer section 119 according to the amount of transmission of image data files transmitted from the image transmission section 107 to the cloud data storage section 118, without waiting for termination of the image recognition process.

Further, in a case where it is determined that an error has occurred, based on a state of the cloud virtual computer section 119 which is sequentially monitored by the cloud monitoring section 110 through inquiry of the cloud virtual computer service 123 about the state, or in a case where the utilization rate of a CPU of the cloud virtual computer section 119 is high and a utilization rate set in advance continues longer than a setting time period, similarly, the cloud virtual computer section 119 may be scaled out such that a plurality of cloud virtual computer sections 119 are activated.

Note that the term “scale out”, mentioned here, refers to increasing the number of cloud virtual computer sections 119 according to the instruction from the cloud activation section 109 of the cloud controller 108 to the cloud virtual computer service 123, thereby causing the image reception process, the image recognition process, and the result transmission process to be performed by distributed processing, with a view to improving the performances of these processes by the cloud virtual computer section 119. By scaling out the cloud virtual computer section 119 according to the instruction from the cloud activation section 109, it is possible to enhance the throughput of the whole image processing system. Note that it is possible not only to scale out the cloud virtual computer section 119 but also to scale in the cloud virtual computer section 119 by termination of a cloud virtual computer section 119 so as to reduce the number of cloud virtual computer sections 119.

The cloud virtual computer section 119 includes an image reception section 120, the recognition processor 121, and a result transmission section 122.

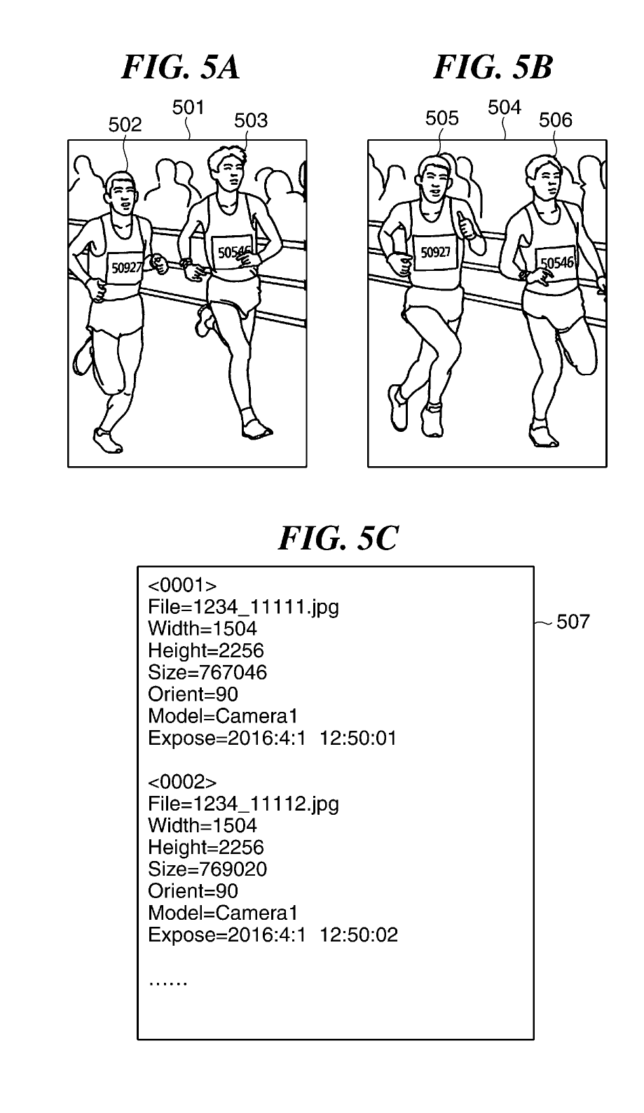

When the cloud virtual computer section 119 is activated by the cloud activation section 109 via the cloud virtual computer service 123, the image reception section 120 sequentially reads a moving image file and an image information file associated therewith or image files in the cloud data storage section 118 into the cloud virtual computer section 119. The image information file will be described hereinafter with reference to FIGS. 5A to 5C.

In a case where a moving image file is read into the cloud virtual computer section 119, the recognition processor 121 converts the moving image file to raster images of respective frames, reads in information, such as rotation directions and file names, from the image information file associated with the moving image file, and then associates the information with the raster images as information thereon. Further, in a case where the image files as still images are read in, the recognition processor 121 directly converts the still images to raster images, and reads information, such as a JPEG marker. Furthermore, the recognition processor 121 performs person detection, number area estimation, character recognition, face authentication, etc. on the raster images, and calculates results of recognition of persons in the image files.

The result transmission section 122 writes e.g. file names of image files stored in the storage 102 of the image accumulation section 101, which are associated with the raster images based on the image information files, and recognized bib numbers, in a CSV (Comma-Separated Values) format, as the results of recognition by the recognition processor 121, and stores them in the cloud data storage section 118.

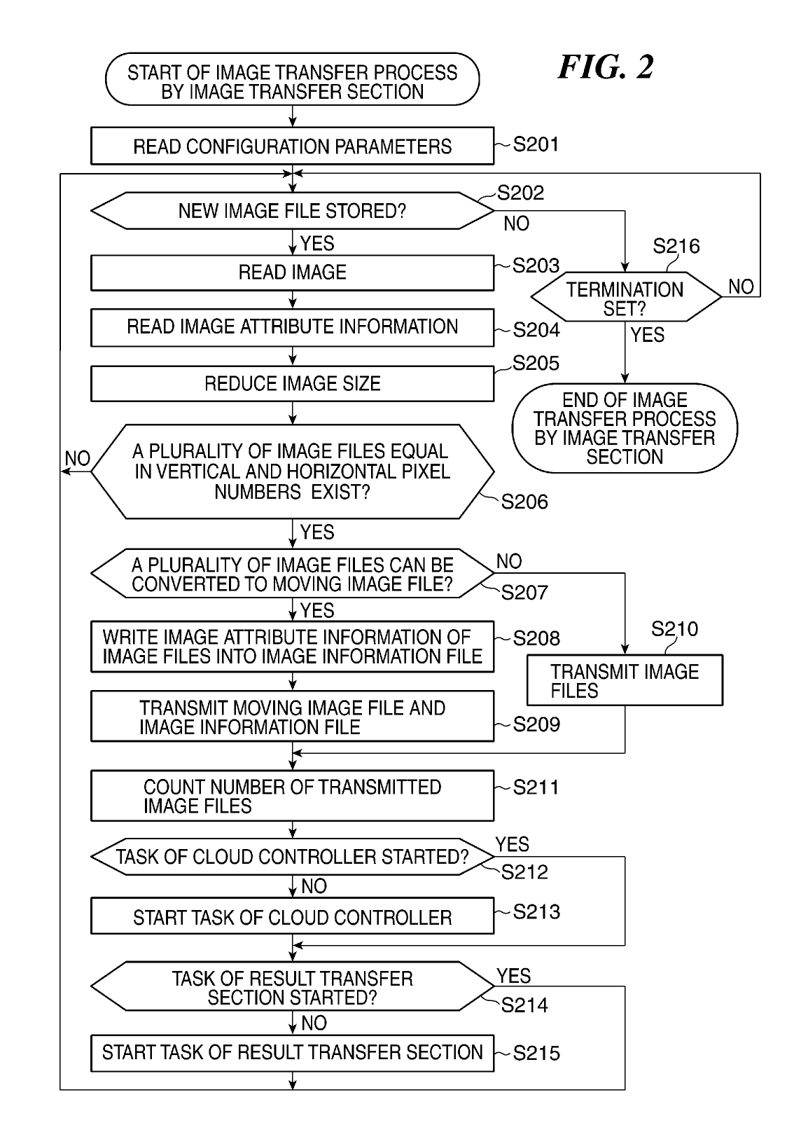

FIG. 2 is a flowchart of an image transfer process performed by the image transfer section 104 of the data transfer section 103. The following description will be given assuming that there are respective tasks for the image transfer section 104, the cloud controller 108, and the result transfer section 112.

When the task of the image transfer section 104 is started, the image transfer section 104 reads configuration parameters concerning the storage 102 of the image accumulation section 101, the storage 117 of the resultant data accumulation section 116, and the cloud data storage section 118 (step S201).

The term “configuration parameters”, mentioned here, refers to IP addresses of the image accumulation section 101 and the resultant data accumulation section 116 in the intranet, and information indicative of paths of folders in the storage 102 and the storage 117. Further, the configuration parameters correspond to access information and path information of the cloud data storage section 118.

When an IP address or a folder in the storage 102 of the image accumulation section 101, which is sequentially monitored by the image detection section 105, is set, the image detection section 105 checks whether or not a new image file to be subjected to the image recognition process is stored in the storage 102 (step S202). Whether a detected file is an image file already subjected to the image recognition process or a new image file is determined, for example, in the following manner: A file name or an extension of the image file already subjected to the image recognition process is changed, or the image file already subjected to the image recognition process is moved from a monitored folder in the storage 102 to a folder other than the monitored folder, or the file name of the image file already subjected to the image recognition process is written into a file other than the image file, whereby in a case of not moving the image file already subjected to the image recognition process to a folder other than the monitored folder, by comparing a file name or extension of the detected file, with the changed file name or extension or a file name or extension of the other file.

If a new image file is stored (YES to the step S202), the image detection section 105 reads the image file into the image transfer section 104 (step S203). At this time, the image file is in a format compressed by JPEG (Joint Photographic Experts Group) for still images. In the present embodiment, a format other than JPEG may be used insofar as still images have raster images and image attributes.

The image conversion section 106 converts the image file to a raster image, and reads image attribute information, such as vertical and horizontal pixel numbers and rotation information, from the JPEG marker and the like (step S204). Here, the image conversion section 106 acquires image attributes concerning the vertical and horizontal pixels and an image rotation direction, which are set in a header of the read image file, and acquires vertical and horizontal minimum pixel numbers set in advance and required for the image recognition process. A minimum pixel size is set to a size required for the image recognition process in a height direction of persons in each image.

In a case where the vertical pixel number and/or the horizontal pixel number are/is larger than required, the image conversion section 106 reduces the image size to a size required for the image recognition process (step S205). At this time, in a case where the rotation direction of an image is 0 degrees or 180 degrees, the image conversion section 106 determines that the camera was placed in the horizontal direction (the image is in landscape orientation), and compares the vertical pixel number of the image in the height direction of persons with a vertical minimum pixel number. If the vertical pixel number of the image is larger, the image conversion section 106 reduces the size of the image such that the vertical pixel number of the image becomes equal to the vertical minimum pixel number, while maintaining an aspect ratio of the image, i.e. reduces the vertical pixel number to the vertical minimum pixel number, and reduces the horizontal pixel number as well, such that the aspect ratio is maintained. On the other hand, in a case where the rotation direction of the images is 90 or 270 degrees, the image conversion section 106 determines that the camera was placed in the vertical direction (the image is in portrait orientation), and compares the vertical pixel number of the image in the height direction of persons (the horizontal pixel number of the image assuming that the image is converted to an image in landscape orientation) with a vertical minimum pixel number. If the vertical pixel number of the image (the horizontal pixel number of the image in landscape orientation) is larger, the image conversion section 106 reduces the size of the image such that the vertical pixel number of the image becomes equal to the vertical minimum pixel number, while maintaining the aspect ratio of the image, i.e. reduces the vertical pixel number of the image (the horizontal pixel number of the image in landscape orientation) to the vertical minimum pixel number, and reduces the horizontal pixel number as well such that the aspect ratio is maintained. In each of the above-described cases, in a case where the pixel number of the image is smaller than the minimum pixel number, a magnification/reduction process of the image is not performed. That is, since the size required for the image recognition process depends on the size of persons in the image file, the pixel numbers of the image in the height direction of persons may be determined based on vertical and horizontal rotation information (information on the landscape or portrait orientation) of the image, and a required pixel number may be changed according to each of vertical and horizontal orientations.

The image conversion section 106 checks whether or not there are a plurality of image files which are equal to each other in both the vertical and horizontal pixel numbers (step S206). If there are no image files which are equal to each other in both the vertical and horizontal pixel numbers (NO to the step S206), the process returns to the step S202 so as to check a next new image file.

If there are a plurality of image files which are equal to each other in both the vertical and horizontal pixel numbers (YES to the step S206), the image conversion section 106 converts the plurality of still images to images of respective frames of one moving image file. Here, the maximum number of frames may be set such that it does not take much time to complete the processing.

If the conversion of the still images to the moving image file is successful (YES to a step S207), the image conversion section 106 creates an image information file, and records image attribute information of the image files converted to the moving image file, in the created image information file (step S208). Here, the format of the image attribute information may be a text file. For example, the file names of the image files are the same as those of the moving image file so as to make clear the relationship between the image files and the moving image file, only with different extensions between the image files and the moving image file. Further, only a moving image file may be used which is extended to have image attribute information of the plurality of image files additionally written therein.

Next, the image transmission section 107 sequentially transmits the moving image file converted from the image files and the image information file associated therewith to a folder in the cloud data storage section 118 which is formed in association with photographing attributes set in the image detection section 105 on an event-by-event basis, on a cameraman-by-cameraman basis, or on a camera type-by-camera type basis (step S209).

In a case where it is impossible to convert the image files to one moving image file e.g. due to insufficient work memory (NO to the step S207), the image transmission section 107 directly transmits the image files to the folder in the cloud data storage section 118 (step S210).

The image transmission section 107 counts the number of the transmitted image files (step S211).

The image transmission section 107 checks whether or not the task of the cloud controller 108 has already been started (step S212). If the task has not been started (NO to the step S212), the image transmission section 107 starts the task of the cloud controller 108 (step S213).

Further, the image transmission section 107 checks whether or not the task of the result transfer section 112 has already been started (step S214). If the task has not been started (NO to the step S214), the image transmission section 107 starts the task of the result transfer section 112 (step S215).

The process returns to the step S202 directly, if the answer to the question of the step S214 is affirmative (YES), or via the step S215, if the same is negative (NO), so as to check whether or not a new image file is stored. If no new image file is stored (NO to the step S202), it is checked whether or not the termination of the task of the image transfer section 104 has been set (step S216). If the termination of the task of the image transfer section 104 has been set (YES to the step S216), the image transmission section 107 terminates the task of the image transfer section 104. Here, the termination setting may be input by an operation of an operator. Further, the termination setting may be made e.g. by causing the last image file to have a special file name or special image attribute information.

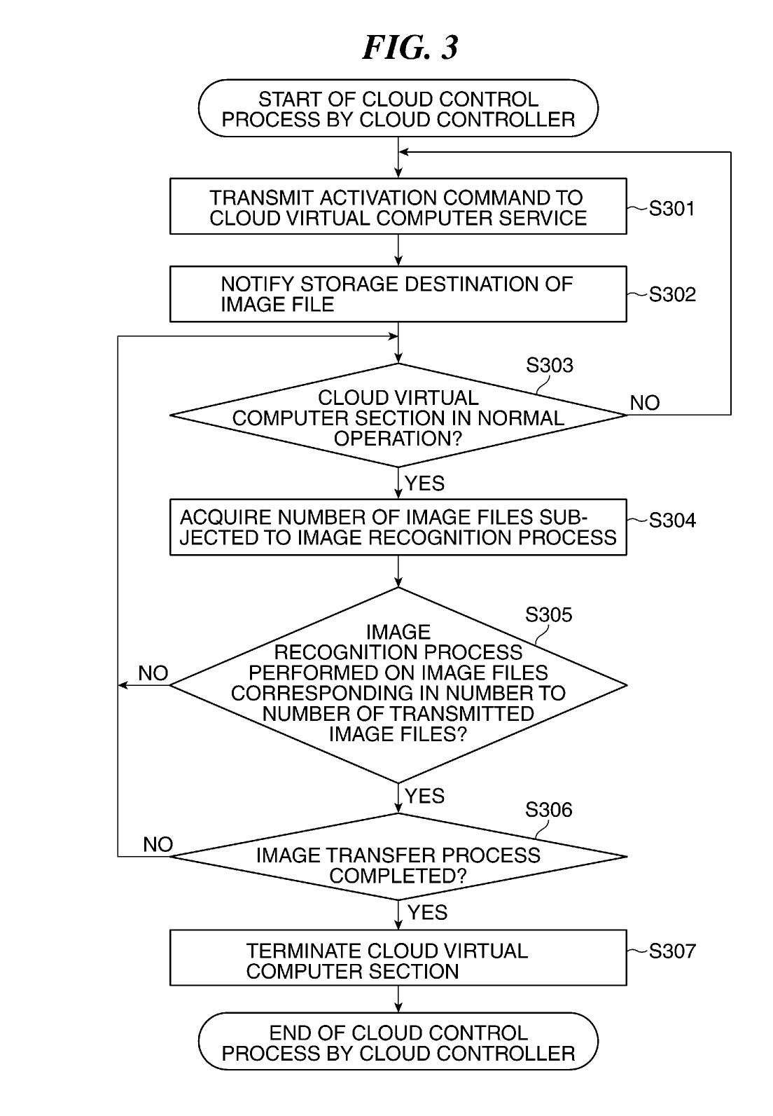

FIG. 3 is a flowchart of a cloud control process performed by the cloud controller 108 of the data transfer section 103.

When the task of the cloud controller 108 is started, the cloud activation section 109 transmits an activation command to the cloud virtual computer service 123 in association with an image folder, and activates the cloud virtual computer section 119 (step S301). Here, the CPU, memory configuration and the like of the cloud virtual computer section 119 may be determined according to the size, number, or complexity of the image files, and the cloud virtual computer section 119 is not always required to have the same specifications.

Next, the cloud activation section 109 writes a path or the like indicating a storage destination (folder) of an image data file to be input to the cloud data storage section 118, in a storage area (e.g. tag information) which can be referred to by the cloud virtual computer section 119, and then notifies the cloud virtual computer section 119 of the fact (step S302).

The cloud monitoring section 110 monitors the state of the cloud virtual computer section 119 activated on an as needed basis while inquiring of the cloud virtual computer service 123 about the state (step S303), and in a case where the image recognition process has not been normally started, as in a case where the cloud virtual computer section 119 is stopped (NO to the step S303), the process returns to the step S301 so as to cause the cloud activation section 109 to activate the associated cloud virtual computer section 119 again.

In a case where it is determined that the activated cloud virtual computer section 119 is normally operating (YES to the step S303), the cloud monitoring section 110 refers to tag information rewritable by the cloud virtual computer sections 119, and acquires the number of image files subjected to the image recognition process by the recognition processor 121 (step S304).

The cloud monitoring section 110 checks with the result transfer section 112 for whether or not the image recognition process has been performed on the number of the transmitted image files, counted by the image transfer section 104 in the step S211 in FIG. 2 (step S305). If the image recognition process has not proceeded until the number of the image files subjected to the image recognition process becomes equal to the number of the transmitted image files (NO to the step S305), the process returns to the step S303 so as to check again whether or not the cloud virtual computer section 119 is normally operating.

If the image recognition process has proceeded until the number of the image files subjected to the image recognition process becomes equal to the number of the image files transmitted to the cloud data storage section 118 (YES to the step S305), the cloud monitoring section 110 checks whether or not the image transfer process has been completed (step S306). In a case where the answer to the question of the step S216 in FIG. 2 is affirmative (YES), the image transfer process by the image transfer section 104 is completed.

If the image transfer process has not been completed (NO to the step S306), it is determined that a further image transfer process is to be performed, and the process returns to the step S303 so as to check again whether or not the cloud virtual computer section 119 is normally operating.

If the image transfer process has been completed (YES to the step S306), the cloud termination section 111 transmits a termination command to the cloud virtual computer service 123, and terminates the cloud virtual computer section 119 to terminate the cloud control process (step S307).

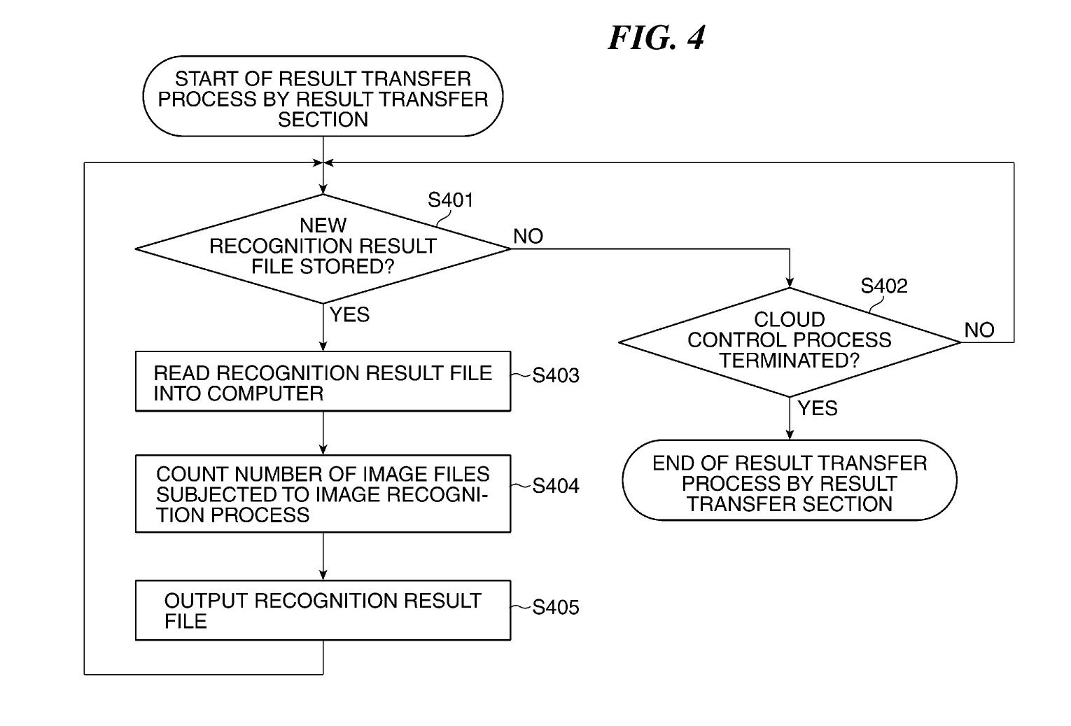

FIG. 4 is a flowchart of a result transfer process performed by the result transfer section 112 of the data transfer section 103.

When the task of the result transfer section 112 is started, the result detection section 113 checks whether or not a new recognition result file is stored in a predetermined folder in the cloud data storage section 118 (step S401).

If no new recognition result file is stored (NO to the step S401), the result detection section 113 checks whether or not the cloud control process by the task of the cloud controller 108 has been terminated (step S402).

If the cloud control process has not been terminated (NO to the step S402), the process returns to the step S401 so as to check whether or not a new recognition result file is stored.

If the cloud control process has been terminated (YES to the step S402), the task of the result transfer section 112 is terminated. At this time, the cloud controller 108 has already terminated the cloud virtual computer section 119 in the step S307 in FIG. 3, whereby the cloud control process by the cloud controller 108 has been terminated.

If a new recognition result file is stored (YES to the step S401), the result reception section 114 reads the recognition result file into the result transfer section 112 (step S403).

The result reception section 114 counts the number of image files subjected to the image recognition process by the recognition processor 121, which has been recorded in the recognition result file (step S404). The result transmission section 115 outputs the recognition result file to a folder set in the storage 117 (step S405).

Next, the process returns to the step S401, wherein the result detection section 113 checks whether or not a new recognition result file is stored, to continue the process.

FIGS. 5A to 5C are diagrams useful in explaining an example of a moving image file generated as a transfer file by the image conversion section 106 of the image transfer section 104.

In an image file 501 and an image file 504 as two still images shown in FIGS. 5A and 5B, respectively, runners (a runner 502, a runner 503, 505, and a runner 506) appear as taken figures, and in the respective image files (photographs), it is possible to perform inter-image difference compression between the image files by focusing on the moving vectors of the runners.

For example, by performing moving image compression by MPEG-4 AVC(H.264) which uses inter-frame prediction technology using a plurality of reference frames, it is possible to compress images in a plurality of image files into one moving image file. H.264 is one of moving image compression standards, and employs space conversion, inter-frame prediction, quantization, and entropy coding. By performing inter-frame prediction using a plurality of reference frames, it is possible to realize a high compression ratio of a moving image, such as images obtained by continuously photographing the same object, in which there is a strong correlation between each pair of successive images. Note that the moving image compression standard is not limited to H.264, but any moving image compression standard may be used insofar as it employs inter-frame prediction.

Here, the file names and the like of image files (still image JPEG, etc.) are collected into an image information file shown in FIG. 5C. The image information file, denoted by reference numeral 507, shows contents of the file, by way of example. Fifteen still images in JPEG, for example, can be converted to a moving image file having fifteen frames.

Next, a description will be given of the contents (still image information) of the image information file 507 with reference to FIG. 5C.

The still image information includes, in order from above, the file name (File) of an image file, a horizontal pixel number (Width), a vertical pixel number (Height), the file size (Size) of the image file, the rotation direction (Orient) of an image, the model name (Model) of a camera used for photographing the image, and a photographing time period (Expose).

The image conversion section 106 generates the image information file 507 having the same file name as the file name of the generated moving image file, and the image transmission section 107 stores the moving image file and the image information file 507 having a different extension from that of the moving image file, simultaneously in a folder in the cloud data storage section 118, which is associated with the photographing attributes set in the image detection section 105 on an event-by-event basis, on a cameraman-by-cameraman basis, or on a camera type-by-camera type basis.

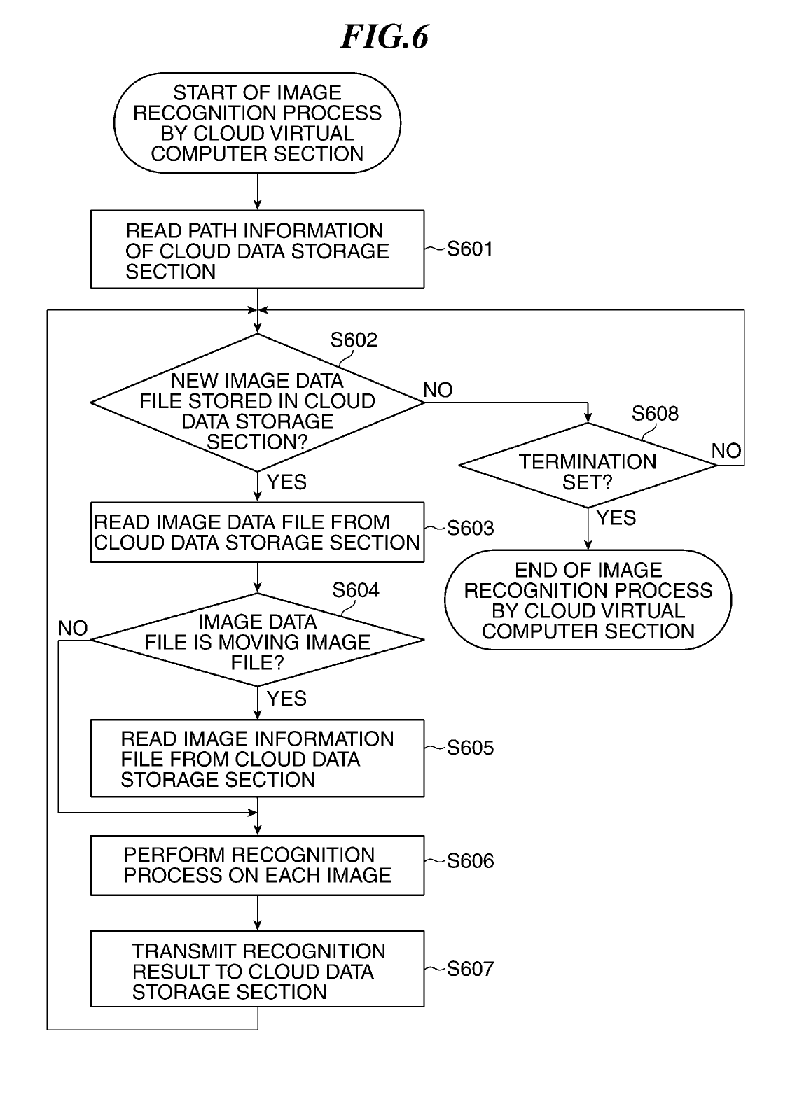

FIG. 6 is a flowchart of the image recognition process performed by the cloud virtual computer section 119.

When the image recognition process by the cloud virtual computer section 119 is started, the image reception section 120 reads path information indicative of a file storage destination (folder) for storing an image data file in the cloud data storage section 118, from a storage area set in the cloud virtual computer section 119, for storing tag information and the like (step S601).

The image reception section 120 checks whether or not a new image data file is stored in the folder in the cloud data storage section 118, indicated by the path and associated with the photographing attributes set in the image detection section 105 on an event-by-event basis, on a cameraman-by-cameraman basis, or on a camera type-by-camera type basis (step S602).

If a new image data file is stored (YES to the step S602), the image reception section 120 reads the image data file from the cloud data storage section 118, and converts the image data file to a raster image or raster images (step S603).

Next, the image reception section 120 checks whether or not the new image data file is a moving image file (step S604). If the image data file is a moving image file (YES to the step S604), the image reception section 120 reads the associated image information file from the cloud data storage section 118, and sets the image information file as image attribute information of the raster image(s) (step S605). Here, in a case where the image property of the image information file indicates a rotation other than a rotation of 0 degrees, each raster image is rotated in a proper direction.

If the image data file is not a moving image file (NO to the step S604), the image reception section 120 sets image attribute information read e.g. from the JPEG marker as image attribute information of the raster image, and then proceeds to a step S906. Here, similarly, in the case where the image attribute information indicates a rotation other than the rotation of 0 degrees, the raster image is rotated in a proper direction.

The recognition processor 121 performs person detection, number area estimation, character recognition, face authentication, and so forth on the raster image(s), and calculates recognition results (step S606).

The result transmission section 115 writes the file name of the image data file, recognized numbers, and the like, as the recognition results in a recognition result file e.g. in a CSV format, and transmits the recognition result file to the cloud data storage section 118 (step S607). Then, the process returns to the step S602 so as to check whether or not a new image data file is stored in the cloud data storage section 118.

If a new image data file is not stored in the cloud data storage section 118 (NO to the step S602), it is checked whether or not termination of the image recognition process is set (step S608). In a case where the termination of the image recognition process is set (YES to the step S608), the image recognition process by the cloud virtual computer section 119 is terminated. If the termination is not set (NO to the step S608), the process returns to the step S602 again so as to check whether or not a new image file is stored.

As described heretofore, in the present embodiment, in the image recognition process of still image data, the cloud virtual computer section 119 for performing the image recognition process is scaled out to generate a plurality of cloud virtual computer sections 119 in order to enable parallel processing when image data to be subjected to the image recognition process is stored in the image accumulation section 101 of the image transfer device 10. Further, conversion of still image data obtained by continuous photographing to continuous moving image data is performed by reducing the size of the still image data to a size required for the image recognition process and executing inter-image difference compression, and the resulting moving image data is efficiently transferred to the cloud data storage section 118 (cloud service). Further, the number of image files transmitted to the cloud service and the number of image files subjected to the image recognition process are compared, and results of the comparison are checked. This makes it possible for the cloud virtual computer section 119 on the Internet to perform the image recognition process of image data in real time at high speed and also with high reliability.

Although in the above-described embodiment, the description is given of a case where the image recognition process is performed by converting image files newly stored in the storage 102 of the image accumulation section 101 provided in the image transfer device 10, to a moving image file, and transfer the moving image file to the cloud computer, this is not limitative. For example, the image recognition process may be performed not by transferring a moving image file from the image transfer device 10 on the intranet side, but by directly storing a moving image file after converting image files thereto from a camera into a storage of the image recognition device 20 of the cloud computer, and the cloud controller 108 in the intranet monitors the storage for a new image file stored therein. The cloud virtual computer section 119 is scaled out based on results of the monitoring. In addition, the camera and the image transfer device 10 may have an integrally formed structure.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-118737 filed Jun. 15, 2016 which is hereby incorporated by reference herein in its entirety.

What is claimed is:

1. An image transfer method of an image transfer device interconnected to an image recognition device via a network, comprising:
storing image data received from an outside in an image storage section;
generating moving image data in which moving image frames are formed from the image data stored in the image storage section by said storing; and
transmitting the moving image data generated by said generating to the image recognition device.

2. The image transfer method according to claim 1, further comprising:
detecting that the image data has been stored in the image storage section; and
instructing activation of a virtual computer included in the image recognition device, based on photographing attributes of the image data detected by said detecting.

3. The image transfer method according to claim 2, further comprising:
receiving a processing result of predetermined processing on the image data from the image recognition device; and
instructing termination of the virtual computer the activation of which has been instructed, based on the processing result received by said receiving.

4. An image recognition method of an image recognition device interconnected to an image transfer device via a network, comprising:
activating at least one virtual computer by a virtual computer controller;
storing moving image data received from the image transfer device in a moving image storage section;
receiving the moving image data stored in the moving image storage section, by said at least one virtual computer;
performing an image recognition process on image data rasterized from the received moving image data, by said at least one virtual computer;
transmitting a processing result of the image recognition process to the moving image storage section, by said at least one virtual computer; and
terminating said at least one virtual computer, by said virtual computer controller, based on an instruction from the image transfer device after termination of the image recognition process.

5. The image recognition method according to claim 4, wherein said activating of said at least one virtual computer includes activating a plurality of the virtual computers, depending on the moving image data stored in the moving image storage section.
